(19) United States
(12) Patent Application Publication
(10) Pub. No.: US 2009/0058624 A1
(43) Pub. Date: Mar. 5, 2009

(54) COGNITIVE ALERTER

(75) Inventors: Mark Edward Kane, Orange Park, FL (US); James Francis Shockley, Orange Park, FL (US)

Correspondence Address: DLA PIPER LLP (US);ATTN: PATENT GROUP, 500 8th Street, NW, WASHINGTON, DC, 20004-2131, US

(73) Assignee: QUANTUM ENGINEERING, INC., Orange Park, FL (US)

(21) Appl. No.: 11/846,156

(22) Filed: Aug. 28, 2007

(51) Int. Cl. B60T 7/12; G08B 21/00

(52) U.S. Cl. 340/439; 180/272

(57) ABSTRACT

A system and method for ensuring that an operator remain alert includes monitoring the operator to determine when the operator is actively working the train controls, and, when the operator has not actively worked the controls for a first period of time, displaying a sequence the repetition of which requires cognitive alertness of the operator. If the operator fails to repeat the sequence, or a corresponding sequence, the train is stopped. In some embodiments, the cognitive alerter is inoperative below predetermined speed levels.

### BACKGROUND

Ensuring that an operator of a train remains alert while operating the train continues to be an important issue in the railroad industry. This is true for all trains, including those that are operated manually and those that involve some form of collision avoidance or positive train control.

In response to the need for ensuring that a train operator remains alert, a number of systems have been developed or proposed. Such systems are sometimes referred to in the art as alerters, and are sometimes stand-alone systems and at other times are integrated into positive train control or collision avoidance systems. These systems typically require the operator to take some action (e.g., push a button, flip a switch, etc.) in response to some stimulus (e.g., a bell an image on a screen, etc.) at various times and, if the action is not taken, stop the train by engaging the brakes and/or putting the locomotive into neutral.

Some known problems are that the systems do not adequately ensure that an operator is alert. For example, one type of train control system known in the art as the cab signal system only requires an operator to acknowledge an audible alarm signal by pressing a button. As discussed in U.S. Pat. No. 6,903,658, it is known that operators can successfully acknowledge audible signals by pushing a button while in a semi-conscious state referred to as “micro-sleep.” Micro-sleep typically occurs when an operator has successfully brought the train into balance (i.e., the train has accelerated to a desired speed and the throttle is in a desired notch, the brake pipe pressure is correctly set, and other controls on the train are in their desired positions) and the operator has nothing to do other than stay alert.

Another problem with some known systems concerns the timing of the operator stimulus. For example, U.S. Pat. No. 5,392,030 to Adams describes a system in which an operator is required to key in a sequence of alphanumeric characters that is displayed on a screen at random times. Requiring the operator to respond to the alerter system at random time intervals (or at fixed time intervals) raises the possibility that the operator will be asked for a response during a time period in which the operator is actively controlling the train and is therefore alert. Asking the operator to respond to an alerter system while he is actively controlling the train is not necessary and therefore unnecessarily annoying because the operator is alert at such times, and is also undesirable because it draws the operator's attention away from the operation of the train at a time when he or she would otherwise be operating one of the controls on the train.

### BRIEF DESCRIPTION OF THE DRAWINGS

FIG. 1 is a block diagram of an alerter system according to an embodiment of the invention.

FIG. 2 is a flowchart of the operation of the alerter system of FIG. 1.

### DETAILED DESCRIPTION

In the following detailed description, a plurality of specific details, such as time periods and types of sequences displayed to a train operator, are set forth in order to provide a thorough understanding of the preferred embodiments discussed below. The details discussed in connection with the preferred embodiments should not be understood to limit the present invention. Furthermore, for ease of understanding certain method steps are delineated as separate steps; however, these steps should not be construed as necessarily distinct nor order dependent in their performance.

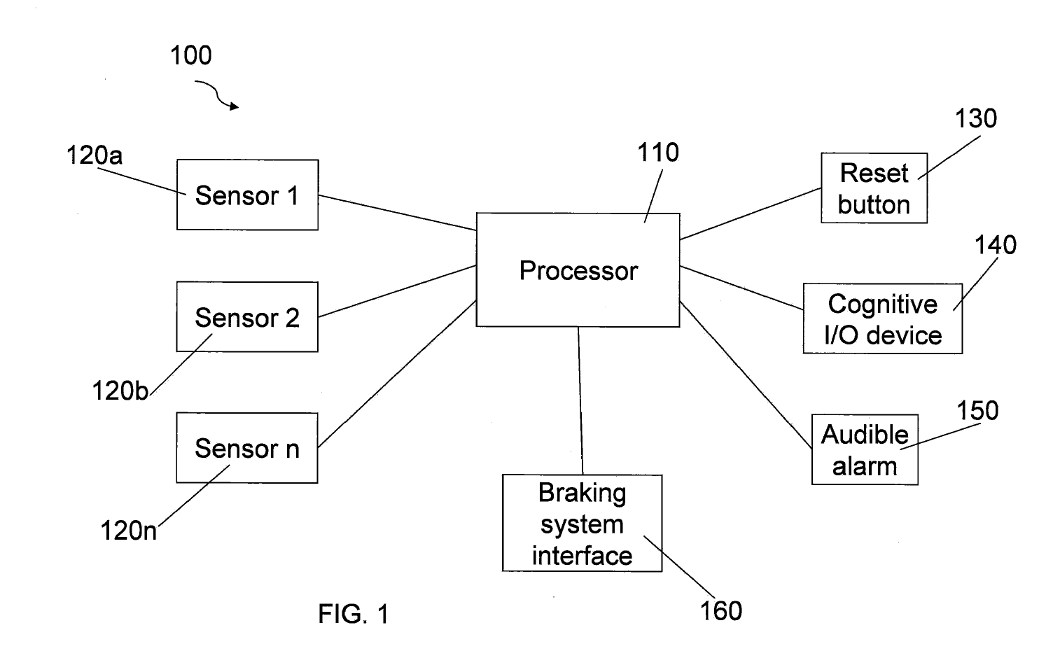

A train control system 100 is illustrated in FIG. 1. It should be understood that the system 100 may be a standalone system or may be integrated into another system such as a train control system (e.g., a cab signal system, a positive train control system, etc.). The system 100 includes a processor 110. The processor 110 may be a microprocessor or microcontroller, or may be implemented using discrete logic components or any other method known in the art.

Connected to the processor 110 are a plurality of sensors 120a-n. The sensors 120a-n are configured to detect operation of a locomotive control, which may be electrical, mechanical or pneumatic, by the operator. The sensors 120a-n may include components that are incorporated into such controls. For example, a sensor for monitoring operator movement of a locomotive throttle may be realized by connecting a control signal corresponding to the throttle position that is used by the propulsion system to control the train's electric motors to the processor 110. In such a case, the sensor would include the electrical connection between the processor and the control signal as well as the components of the throttle assembly that translate movement of the throttle handle to the electrical signal that is input to the processor 110. Alternatively, a sensor for the throttle handle may include additional components (e.g., a potentiometer that is physically connected to the throttle handle) in addition to those provided with the throttle assembly to generate a signal based on a position of the throttle handle. Any type of components may be used as sensors 120a-n so long as such components provide a reliable indication that the operator is taking some action to operate the train.

Also connected to the processor 110 is a bag system interface 160. The braking system interface 160 is used to control the bakes of the train. In some embodiments, the braking system interface 160 is an electrically controlled switch that can disrupt power to a P2A valve in a braking system. As is well known in the art, disrupting the power to a P2A valve will result in a penalty brake application that will bring the train to a halt. Other, more sophisticated braking system interfaces that provide for more robust braking system control (e.g., interfaces that provide the ability to slow a train rather than stop it) may also be used in some embodiments.

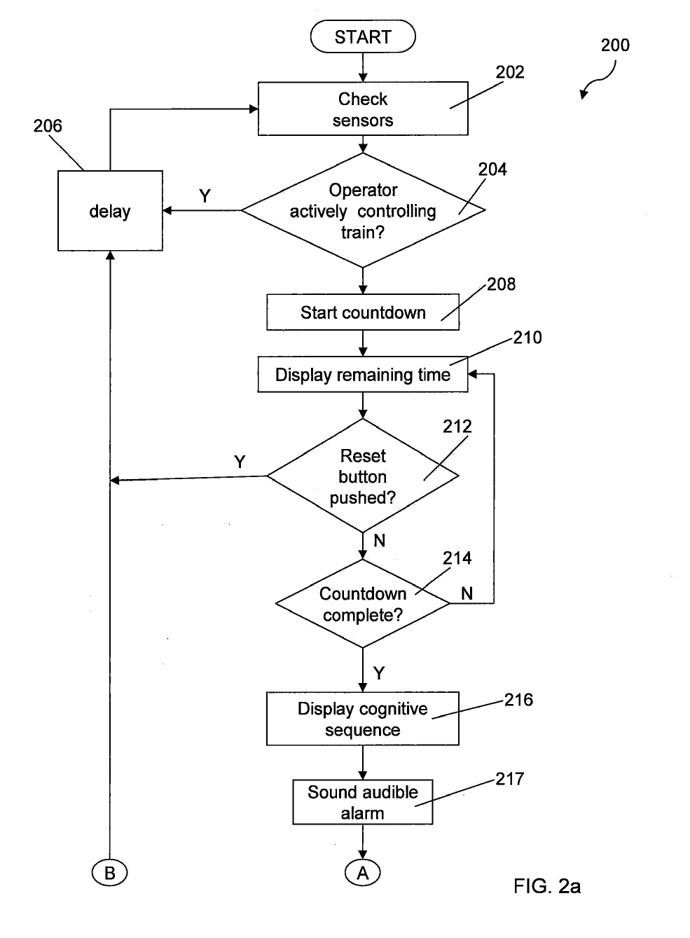

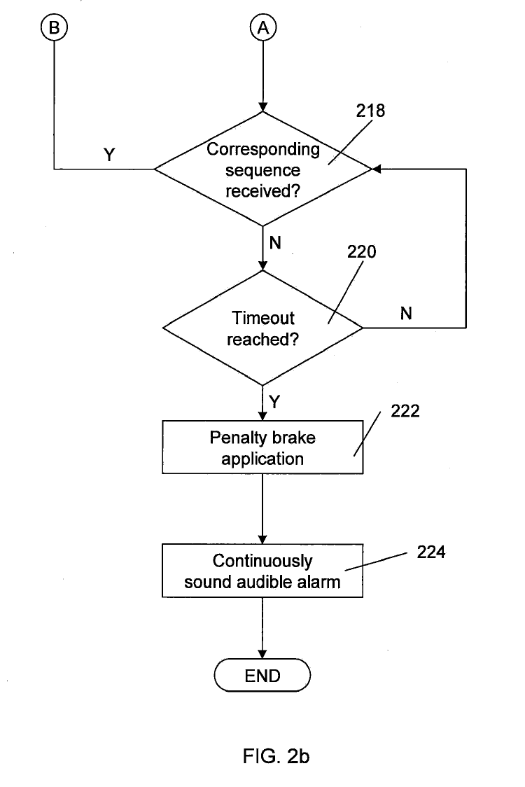

A reset button 130, cognitive I/O device 140, and audible alarm 150 are also connected to the processor 110. These devices may be integrated into a single housing along with the processor 110 and braking system invoice 160, or may be physically separate devices. The reset button 130 is preferably of the momentary contact type and may be used by the operator to reset a countdown period as will be explained in further detail in connection with FIG. 2.

The cognitive I/O device 140 is a device which is capable of displaying a sequence to an operator and accepting a corresponding sequence from the operator. For example, the cognitive I/O device may consist of a simple alphanumeric display (e.g., an LCD or LED display) that is used to display an alphanumeric sequence to an operator, and a keypad that can be used by the operator to enter a corresponding sequence. In other embodiments, other kinds of devices for displaying other kinds of sequences, such as a touchscreen for displaying button sequences such as those described in U.S. Pat. No. 6,903,658, the content of which is incorporated herein. It should be understood that a corresponding sequence may be a matching sequence but is not so limited and may be a reverse sequence (i.e., if 1234 is displayed, 4321 is entered by the operator) or an otherwise-related sequence in some embodiments. Such sequences may be desirable as they require a higher degree of alertness than that required to repeat a sequence.

The audible alarm 150 may be a bell, buzzer, speaker, or any other device capable of creating an audible sound. The audible alarm 150 may also include an air horn as is typically found on a locomotive.

Operation of the system 100 in one embodiment is illustrated in the flowchart 200 of FIG. 2. The processor 110 checks the various sensors 120a-n at step 202. If the sensors indicate that the operator has moved any of the train controls associated with the sensors at step 204 (indicating that the operator is actively controlling the train), then the processor delays for a brief period of time at step 206 and stop 202 is repeated. The precise manner in which the sensors make this indication will vary depending upon the type of sensor. For example, determining whether the operator has operated the throttle requires storage of the setting of the throttle at a time prior to step 202 with which the current setting of the throttle at step 202 can be compared. In contrast, a sensor connected to monitor the operation of a control with a momentary contact such as an air horn will require something akin to a latch that will register a momentary activation until such time as step 202 is performed. The period of time for the delay 206 may be fixed or random. In some embodiments, the period of time for the delay 206 depends on the train's speed. For example, in one embodiment the period of time in seconds is determined by dividing 2400 by the speed of the train in miles per hour (e.g., 2400 seconds/60 mph=40 seconds), such that the delay period decreases as the train's speed increases. In other embodiments, the period of the delay is on the order of a few minutes, but longer or shorter periods are used in yet other embodiments.

If the operator is not actively controlling the train at step 204 (signifying that the operator is not currently actively controlling the train, as would be the case when the train was in balance), the operator is given a fixed period of time in which he or she can manually reset the alerter by simply pressing the reset button 130. In some embodiments, this fixed period of time is ten seconds, but longer or shorter periods may be used in other embodiments. The processor 110 starts a countdown of the fixed time period at step 208 and displays the remaining time in the time period (or, in alternative embodiments, the time elapsed since the start of the time period, leaving it to the operator to recognize how much time is left) on the cognitive I/O device 140 (or on a separate display associated with the reset button or another device) at step 210. This visual time display is preferably the only notice that the operator is given—there is no audible alarm because an operator may successfully press the reset button 130 while in a state of micro-sleep as discussed above. Rather, the visual-only display of the time, at a minimum, requires the operator's eyes to be open and on the time display. This increases the likelihood that the operator is alert. If the operator presses the reset button 130 at step 212, step 206 and the delay associated therewith is repeated. Otherwise, if the countdown is not complete at step 214, step 212 is repeated until the countdown is complete or until the operator presses the reset button 130.

If the countdown ends at step 214 before the operator presses the reset button 130, there is a danger that the operator may not be fully alert. Therefore, the operator is required to perform a task that requires cognitive ability on the part of the operator within a predetermined time period. At step 216, a sequence is displayed on the cognitive I/O device 140 and an audible alarm is sounded at step 217. The audible alarm is used at this point because it is desirable for the operator to be awakened, and the requirement to enter a corresponding sequence ensures that the operator is alert if a correct corresponding sequence is entered by the operator. If a corresponding sequence is received from the operator at step 218, step 206 is repeated.

If the operator fails to enter a corresponding sequence at step 218 prior to expiration of the timeout, it is assumed that the operator is not alert or is otherwise incapacitated and therefore continued movement of the train is unsafe. Accordingly, the processor 110 initiates a penalty brake application at step 222 to stop the train and continuously sounds the audible alarm at step 224. Those of skill in the art will recognize that other brake applications (e.g., an emergency brake application, a full service brake application, or a more gradual brake application, may be used in place of the penalty brake application of step 222. Processing is then complete and the operator is required to perform a manual reset of the system in order to get the train moving again. This ensures that the operator is fully awake before the train moves.

In some embodiments, the events from the cognitive alerter are transmitted to an event recorder. In this way, a record of the operator's alertness is maintained in the same way that other actions taken by the operator are recorded.

In some embodiments, no manual reset button 130 is provided and steps 208-214 of FIGS. 2a and 2b are not performed. Thus, the operator is forced to enter a corresponding sequence each time his alertness is tested. Such embodiments provide greater assurance that the operator is alert but suffer from the drawback of requiring more action by the operator. This increases operator annoyance and provides increased motivation for the operator to tamper with or disable the system 100.

In some embodiments, the cognitive alerter system is disabled when the train's speed is below a threshold. In some embodiments, the threshold is 3 mph. In such embodiments, the operator will not be presented with any sequences or otherwise have his alertness tested when the train is traveling 3 mph or less. This is because an operator is normally paying attention and alert when traveling so slowly.

It will be apparent to those of skill in the art that numerous variations in addition to those discussed above are also possible. Therefore, while the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computerized method for ensuring that an operator remains alert during operation of a train comprising the steps of:
(a) monitoring at least one train control device to determine whether the operator is operating the train control device;
(b) if the operator has not operated the train control device within a first time period, displaying at least one sequence to an operator on a display device;
(c) determining whether the operator has entered a corresponding sequence within a second time period; and
(d) stopping the train if the operator fails to enter the corresponding sequence within the second time period.

2. The method of claim 1, further comprising the steps of:
setting a third time period;
displaying to the operator an indication that the third time period has started prior to displaying the at least one sequence to the operator; and
if the operator has pressed a reset button during the third time period, repeating step (a).

3. The method of claim 1, wherein the first time period is fixed.

4. The method of claim 1, wherein the first time period is randomly chosen.

5. The method of claim 1, wherein the sequence is an alphanumeric sequence.

6. The method of claim 1, further comprising the step of sounding an audible alarm at a start of the second time period.

7. The method of claim 1, further comprising the step of sounding an audible alarm if the operator fails to enter the corresponding sequence within the second time period.

8. The method of claim 1, wherein the train is stopped with a penalty brake application.

9. The method of claim 1, wherein steps (b), (e) and (d) are skipped when a speed of the train is less than a predetermined threshold.

10. A system for ensuring that an operator remains alert during operation of a train, the system comprising:
a processor;
at least one sensor connected to the processor;
a display connected to the processor;
an input device connected to the processor; and
a brake interface connected to the processor;
wherein the processor is configured to perform the steps of
(a) monitoring the at least one sensor to determine whether the operator is operating the train control device;
(b) if the operator has not operated the train control device within a first time period, displaying at least one sequence to an operator on the display,
(c) determining whether the operator has entered on the input device a corresponding sequence within a second time period; and
(d) commanding the brake interface to stop the train if the operator fails to enter the corresponding sequence within the second time period.

11. The system of claim 10, further comprising the steps of:
setting a third time period;
displaying to the operator an indication that the third time period has started prior to displaying the at least one sequence to the operator; and
if the operator has pressed a reset button during the third time period, repeating step (a).

12. The system of claim 10, wherein the first time period is fixed.

13. The system of claim 10, wherein the first time period is randomly chosen.

14. The system of claim 10, wherein the sequence is an alphanumeric sequence.

15. The system of claim 10, further comprising the step of sounding an audible alarm at a start of the second time period.

16. The system of claim 10, further comprising the step of sounding an audible alarm if the operator fails to enter the corresponding sequence within the second time period.

17. The system of claim 10, wherein the train is stopped with a penalty brake application.

18. The system of claim 10, wherein steps (b), (c) and (d) are skipped when a speed of the train is less than a predetermined threshold.
